(19) United States
(12) Patent Application Publication
(10) Pub. No.: US 2010/0311279 A1
(43) Pub. Date: Dec. 9, 2010

(54) Electrical Connector and Illuminating Module

(76) Inventors: Lung CHEN, Hsinchu (TW); Ya-Chuan Yeh, Hsinchu (TW); Jian-Lung Chen, Hsinchu (TW); Chia-Hung Yeh, Hsinchu (TW)

Correspondence Address: LanWay IPR Services, P.O. Box 220746, Chantilly, VA, 20153, US

(21) Appl. No.: 12/610,253

(22) Filed: Oct. 30, 2009

(30) Foreign Application Priority Data
Jun. 9, 2009 (TW) 098210227

(51) Int. Cl. H01R 33/00

(52) U.S. Cl. 439/660

(57) ABSTRACT

An illuminating module includes an illuminating device and an electrical connector. The illuminating device includes a first conductive contact and a second conductive contact. The electrical connector includes an external plug, a first internal conductive terminal and a second internal conductive terminal. The first internal conductive terminal electrically connects the external plug and the first conductive contact. The second internal conductive terminal electrically connects the external plug and the second conductive contact. The connection manner of the first internal conductive terminal and the first conductive contact belongs to fool-proof connection. The connection manner of the second internal conductive terminal and the second conductive contact belongs to fool-proof connection. The misconnection between the first and the second internal conductive terminals of the electrical connector and the first and the second conductive contacts of the illuminating device is prevented by means of the design of the illuminating module.

This application claims priority to a Taiwan application No. 098210227 filed on Jun. 9, 2009.

### BACKGROUND

1. Field of the Invention

The present invention relates to an electrical device and in particular, to an electrical connector and an illuminating module having the electrical connector.

2. Description of the Prior Art

FIG. 1 is a schematic exploded view of a conventional illuminating module. It should be noted that the sectional view of an illuminating device is shown in FIG. 1 for the convenience of description. Referring to FIG. 1, the conventional illuminating module M1 includes an illuminating device 100 and an electrical connector 100′. The conventional illuminating device 100 includes a reflector 110, a lamp 120, a first conductive contact 130 and a second conductive contact 140. The reflector 110 has an opening 112 and a base portion 114 opposite to the opening 112. The lamp 120 is fixed to the base portion 114 and at least partially disposed in the reflector 110. The lamp 120 has a first outer electrode 122 and an second outer electrode 124 opposite to each other. The first outer electrode 122 is adjacent to the opening 112 and the second outer electrode 124 is disposed at the base portion 114.

The first conductive contact 130 is disposed at a right side of the reflector 110 and located outside the reflector 110. The first conductive contact 130 is adjacent to the opening 112. The first outer electrode 122 is electrically connected to the first conductive contact 130 by means of a wire 150 passing through the interior of the reflector 110. The second conductive contact 140 of which the configuration is similar to that of the first conductive contact 130 is disposed at a left side of the reflector 110 and located outside the reflector 110. The second conductive contact 140 is adjacent to the opening 112. The second outer electrode 124 is electrically connected to the second conductive contact 140 by means of a wire 160 passing through the exterior of the reflector 110.

The electrical connector 100′ includes an external plug 110′, a first internal conductive terminal 120′ and a second internal conductive terminal 130′. The first internal conductive terminal 120′ is electrically connected to the external plug 110′ by means of a wire 140′. The second internal conductive terminal 130′ is electrically connected to the external plug 110′ by means of a wire 150′. In addition, the first conductive contact 130 is inserted into the first internal conductive terminal 120′, and the second conductive contact 140 is inserted into the second internal conductive terminal 130′.

When a user intends to activate the illuminating device 100 to turn the lamp 120 on, the user must insert the external plug 110′ of the electrical connector 100′ into a direct-current (DC) power supply (not shown). However, because the shape and the size of the first conductive contact 130 representing the positive electrode are the same as those of the second conductive contact 140 representing the negative electrode and the shape and the size of the first internal conductive terminal 120′ representing the positive electrode are the same as those of the second internal conductive terminal 130′ representing the negative electrode, it is easier for an assemblyman to insert the second conductive contact 140 into the first internal conductive terminal 120′ by mistake and insert the first conductive contact 130 into the second internal conductive terminal 130′ by mistake. Therefore, when the user activate the illuminating device 100 of the illuminating module M1 improperly assembled, the lamp 120 of the illuminating device 100 will be burnt down immediately. Thus, the convention illuminating module M1 is necessarily to be improved.

### BRIEF SUMMARY

The present invention is directed to provide an electrical connector by fool-proof design for preventing the misconnection between the electrical connector and an illuminating device.

The present invention is directed to provide an illuminating module which includes an electrical connector by fool-proof design for preventing the misconnection between the electrical connector and an illuminating device.

The present invention provides an electrical connector applied to an illuminating device having a first conductive contact and a second conductive contact. The electrical connector includes an external plug, a first internal conductive terminal and a second internal conductive terminal. The first internal conductive terminal is electrically connected to the external plug and suitable for being electrically connected to the first conductive contact. The second internal conductive terminal is electrically connected to the external plug and suitable for being electrically connected to the second conductive contact. The connection manner between the first internal conductive terminal and the first conductive contact and the connection manner between the second internal conductive terminal and the second conductive contact belong to fool-proof connection.

The present invention provides an illuminating module including an illuminating device and an electrical connector. The illuminating device includes a first conductive contact and a second conductive contact. The electrical connector includes an external plug, a first internal conductive terminal and a second internal conductive terminal. The first internal conductive terminal electrically connects the external plug and the first conductive contact. The second internal conductive terminal electrically connects the external plug and the second conductive contact. The connection manner between the first internal conductive terminal and the first conductive contact and the connection manner between the second internal conductive terminal and the second conductive contact belong to fool-proof connection.

In one embodiment of the present invention, the connection manner between the first internal conductive terminal and the first conductive contact is different from the connection manner between the second internal conductive terminal and the second conductive contact.

In one embodiment of the present invention, the connection manner between the first internal conductive terminal and the first conductive contact is tight fit. The connection manner between the second internal conductive terminal and the second conductive contact is loose fit. The second internal conductive terminal is fixed to the second conductive contact through a fixing member.

In one embodiment of the present invention, the first internal conductive terminal has a body and two bended portions. Each of the bended portions is connected to the body and keeps a first distance from the body. The bended portions keep a second distance from each other. The first conductive contact is inserted between each of the bended portions and the body so that the first conductive contact is sandwiched between each of the bended portions and the body.

In one embodiment of the present invention, the second internal conductive terminal has a through hole into which the second conductive contact is inserted. The fixing member is a nut which is screwed to the second conductive contact so that the second internal conductive terminal is fixed to the second conductive contact.

In one embodiment of the present invention, the illuminating device includes a reflector and a lamp. The reflector has an opening and a base portion opposite to the opening. The first conductive contact is disposed at the reflector and located outside the reflector. The second conductive contact is disposed at the reflector and at least partly located outside the reflector. The lamp is fixed to the base portion and at least partly disposed in the reflector. The lamp has a first electrode and a second electrode. The first electrode and the second electrode are electrically connected to the first conductive contact and the second conductive contact, respectively.

The connection manner between the first internal conductive terminal and the first conductive contact and the connection manner between the second internal conductive terminal and the second conductive contact belong to fool-proof connection. So, when the electrical connector is assembled to the illuminating device, the first internal conductive terminal is merely connected to the first conductive contact and the second internal conductive terminal is merely connected to the second conductive contact. Therefore, the design of the illuminating module of the present invention can prevent the misconnection between the first internal conductive terminal and the second internal conductive terminal of the electrical connector and the first conductive contact and the second conductive contact of the illuminating device.

### BRIEF DESCRIPTION OF THE DRAWINGS

The accompanying drawings are included to provide a further understanding of the embodiments of the invention, and are incorporated in and constitute part of this specification. The drawings illustrate embodiments of the invention and, together with the description, serve to explain the principles of the invention.

FIG. 1 is a schematic exploded view of a conventional illuminating module.

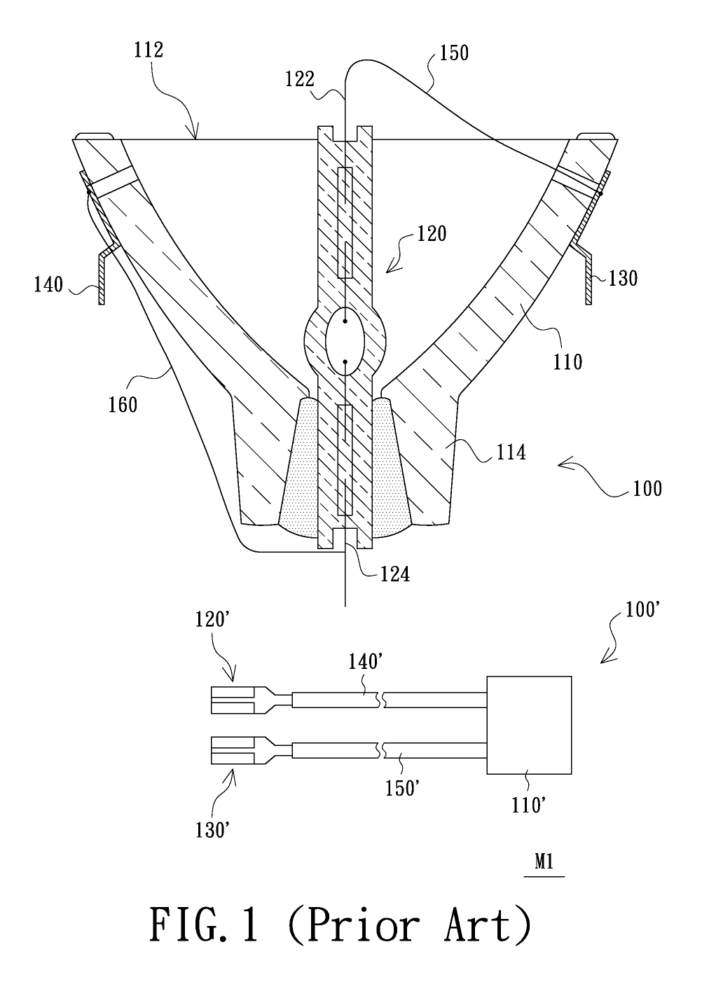

FIG. 2 is a schematic exploded view of an illuminating module according to an embodiment of the present invention.

FIG. 3 is a schematic assembled view of the illuminating module according to the embodiment of the present invention.

FIG. 4 is a schematic cross-sectional view of the electrical connector of the FIG. 2 taken alone the line A-A.

FIG. 5 is a schematic assembled view of an illuminating module according to another embodiment of the present invention.

### DETAILED DESCRIPTION

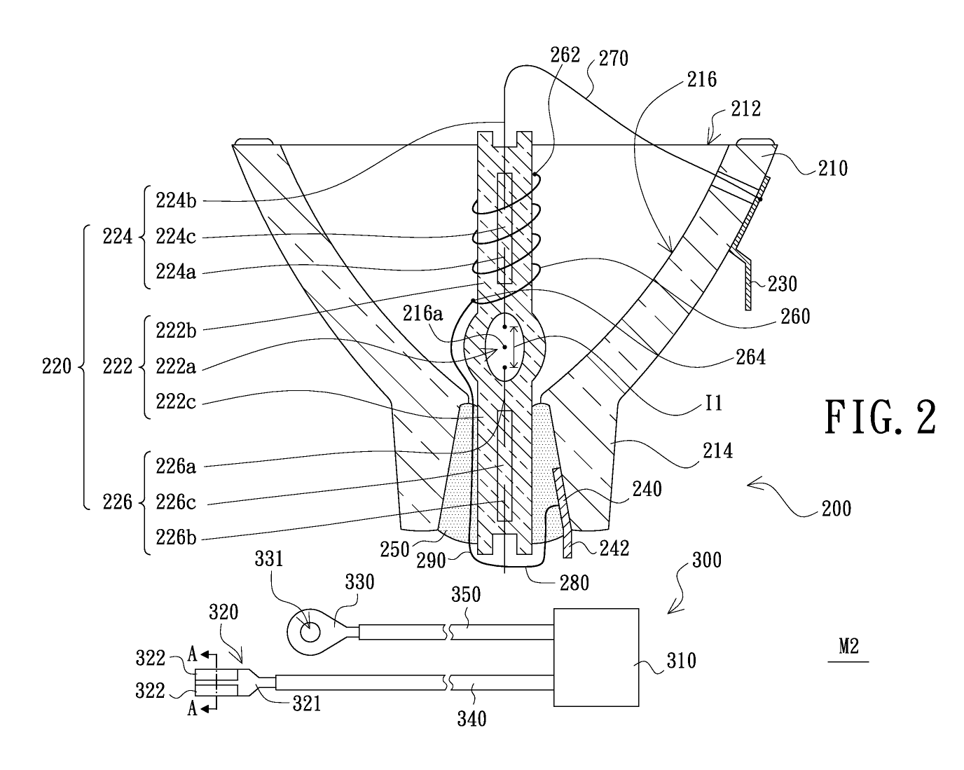

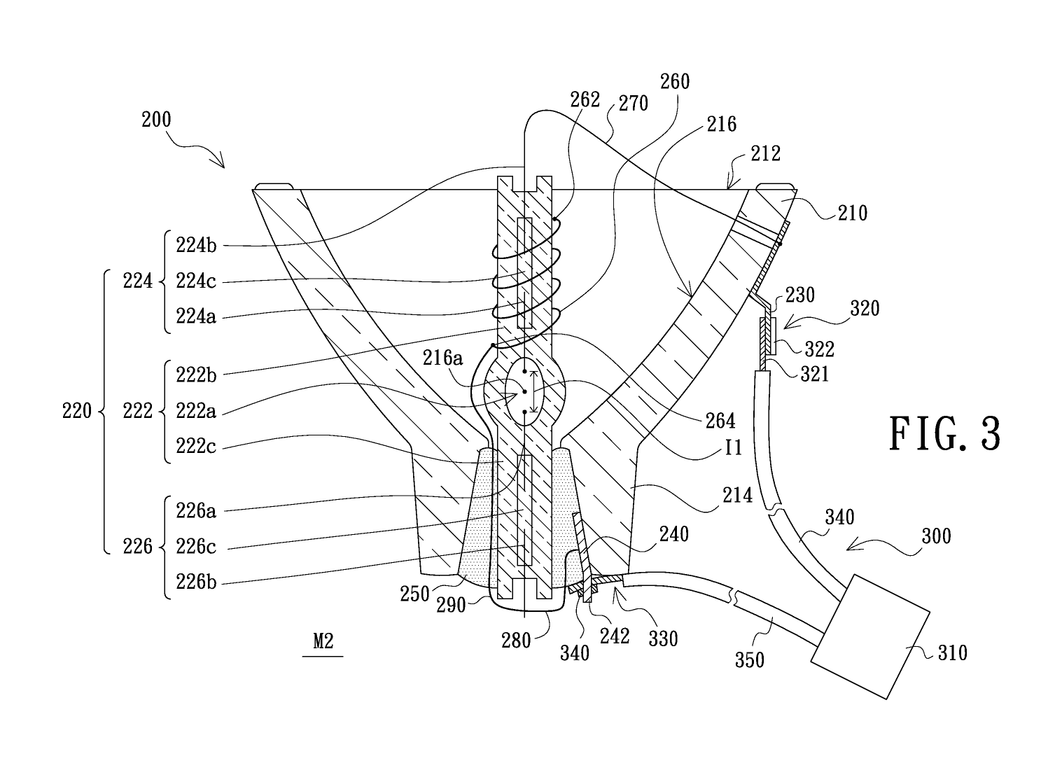

FIG. 2 is a schematic exploded view of an illuminating module according to an embodiment of the present invention. FIG. 3 is a schematic assembled view of the illuminating module according to the embodiment of the present invention. It should be noted that for convenience description, the cross-section of the illuminating device is shown in FIGS. 2 and 3 and the cross-section of the first internal conductive terminal and that of the second internal conductive terminal of the electrical connector are shown in FIG. 3. Referring to FIGS. 2 and 3, the illuminating module M2 includes an illuminating device 200 and an electrical connector 300. The illuminating device 200 includes a reflector 210, a lamp 220, a first conductive contact 230, a second conductive contact 240 and cement 250. The lamp 220 is disposed in the reflector 210. The first conductive contact 230 and the second conductive contact 240 are disposed at the reflector 210. The lamp 220 is electrically connected to the electrical connector 300 through the first conductive contact 230 and the second conductive contact 240.

The reflector 210 has an opening 212 and a base portion 214. The base portion 214 is opposite to the opening 212 and the base portion 214 is, for example, a hollow neck-shaped structure. An inner surface 216 of the reflector 210 is a reflective surface which may be a paraboloid. In addition, the material of the reflector 200 may include glass, ceramic, metal or plastic. The reflector 210 can reflect light generated by the lamp 220 so that the light generated by the lamp 220 is emitted to the outside the reflector 210 through the opening 212.

The lamp 220 is, for example, a gas discharge lamp which is fixed to the base portion 214 of the reflector 210 and at least partly disposed in the reflector 210. The lamp 220 includes a tube 222, a first electrode 224 and a second electrode 226. The tube 222 includes a cavity 222a, a first sealed portion 222b and a second sealed portion 222c opposite to the first sealed portion 222b. The cavity 222a is located between the first sealed portion 222b and the second sealed portion 222c. The second sealed portion 222c is disposed at the base portion 214 through the cement 250 and the first sealed portion 222b is adjacent to the opening 212 of the reflector 210. The cavity 222a of the present embodiment is filled with a filler which can ionize and may be mercury gas or noble gas. In addition, the material of the lamp 222 may be quartz glass.

The first electrode 224 is disposed at the first sealed portion 222b and extends into the cavity 222a and outside the tube 222. Concretely, the first electrode 224 includes a first inner electrode 224a, a first outer electrode 224b and a first electrode-connecting member 224c. The first inner electrode 224a is disposed at the first sealed portion 222b and extends into the cavity 222a. The first outer electrode 224b is disposed at the first sealed portion 222b and extends outside the tube 222 and the first outer electrode 224b is adjacent to the opening 212 of the reflector 210. The first electrode-connecting member 224c is disposed in the first sealed portion 222b and connects the first inner electrode 224a and the first outer electrode 224b. The material of the first inner electrode 224a of the present embodiment may be tungsten, the material of the first outer electrode 224b may be molybdenum or tantalum and the material of the first electrode-connecting member 224c may be molybdenum.

The second electrode 226 is disposed at the second sealed portion 222c and extends into the cavity 222a and outside the tube 222. Concretely, the second electrode 226 includes a second inner electrode 226a, a second outer electrode 226b and a second electrode-connecting member 226c. The second inner electrode 226a is disposed at the second sealed portion 222c and extends into the cavity 222a. The first inner electrode 224a and the second inner electrode 226a maintain an interval I1 in the cavity 222a and a midpoint of the interval I1 is located at a focus point 216a of the inner surface 216 such as a paraboloid. The second outer electrode 226b is disposed at the second sealed portion 222c and extends outside the tube 222. The second electrode-connecting member 226c is disposed in the second sealed portion 222c and connects the second inner electrode 226a and the second outer electrode 226b. The material of the second inner electrode 226a of the present embodiment may be tungsten, the material of the second outer electrode 226b may be molybdenum or tantalum and the material of the second electrode-connecting member 226c may be molybdenum.

The first conductive contact 230 is disposed at a right side of the reflector 210 and located outside the reflector 210. The first outer electrode 224b is electrically connected to the first conductive contact 230 through a wire 270 passing through the interior of the reflector 210. In the embodiment, the first conductive contact 230 is adjacent to the opening 212 of the reflector 210. The second conductive contact 240 is disposed at the base portion 214 of the reflector 210 and at least partly located outside the reflector 210. The second outer electrode 226b is electrically connected to the second conductive contact 240 through a wire 280 passing outside the reflector 210.

In addition, a conductive coil 260 is disposed around the first sealed portion 222b of the tube 222 and includes a free end 262 and a connecting end 264. The connecting end 264 is electrically connected to the second outer electrode 226b through a wire 290 passing through the interior of the reflector 210. When the illuminating device 200 is activated, the conductive coil 260 electrified generates an electric field around the first electrode 224 such that the starting voltage of the illuminating device 200 of the present embodiment is decreased.

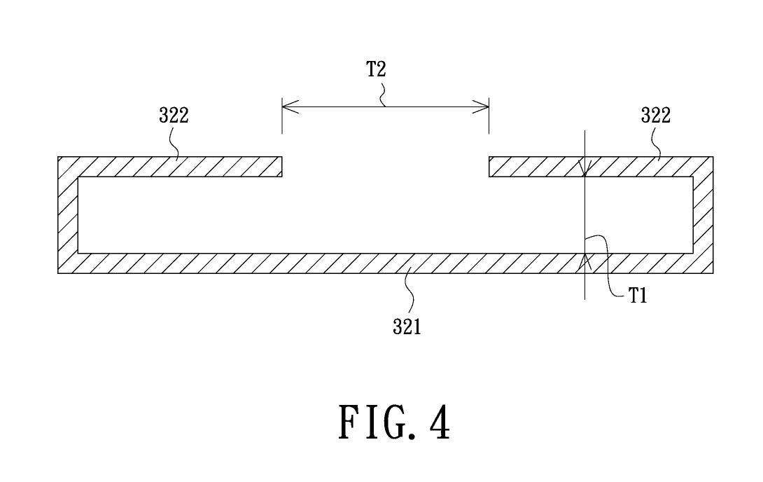

FIG. 4 is a schematic cross-sectional view of the electrical connector of the FIG. 2 taken alone the line A-A. Referring to FIGS. 2, 3 and 4, the electrical connector 300 includes an external plug 310, a first internal conductive terminal 320 and a second internal conductive terminal 330. The first internal conductive terminal 320 is electrically connected to the external plug 310 through a wire 340 and the second internal conductive terminal 330 is electrically connected to the external plug 310 through a wire 350. The first internal conductive terminal 320 is electrically connected to the first conductive contact 230 and the second internal conductive terminal 330 is electrically connected to the second conductive contact 240. In addition, the connection manner between the first internal conductive terminal 320 and the first conductive contact 230 belongs to fool-proof connection and the connection manner between the second internal conductive terminal 330 and the second conductive contact 240 belongs to fool-proof connection.

It should be noted that in the embodiment, that the connection manner between the first internal conductive terminal 320 and the first conductive contact 230 belongs to fool-proof connection means that the first internal conductive terminal 320 is designed for being merely connected to the first conductive contact 230 but can not be connected to the second conductive contact 240. In addition, that the connection manner between the second internal conductive terminal 330 and the second conductive contact 240 belongs to fool-proof connection means that the second internal conductive terminal 330 is designed for being merely connected to the second conductive contact 240 but can not be connected to the first conductive contact 230. In the embodiment, the first conductive contact 230 can be merely inserted into the first internal conductive terminal 320 and the second conductive contact 240 can be merely inserted into the second internal conductive terminal 330. The detail description is given below.

Concretely, the connection manner between the first internal conductive terminal 320 and the first conductive contact 230 is different from the connection manner between the second internal conductive terminal 330 and the second conductive contact 240. In the embodiment, the connection manner between the first internal conductive terminal 320 and the first conductive contact 230 is tight fit. The first internal conductive terminal 320 has a body 321 and two bended portions 322. Each of the bended portions 322 is connected to the body 321 and keeps a first distance T1 from the body 321. The bended portions 322 keep a second distance T2 from each other. In addition, the first conductive contact 230 is inserted between each of the bended portions 322 and the body 321 so that the first conductive contact 230 is sandwiched between each of the bended portions 322 and the body 321.

In the embodiment, the connection manner between the second internal conductive terminal 330 and the second conductive contact 240 is loose fit. The second internal conductive terminal 330 is fixed to the second conductive contact 240 via a fixing member 340. Concretely, the second internal conductive terminal 330 has a through hole 331 into which a column body 242 of the second conductive contact 240 is inserted. The column body 242 of the second conductive contact 240 is, for example, a bolt. The fixing member 340 may be a nut which is screwed to the column body 242 of second conductive contact 240 so that the second internal conductive terminal 330 is fixed to the second conductive contact 240.

The connection manner between the first internal conductive terminal 320 and the first conductive contact 230 belongs to fool-proof connection and the connection manner between the second internal conductive terminal 330 and the second conductive contact 240 belongs to fool-proof connection. So, when the electrical connector 300 is assembled to the illuminating device 200, the first internal conductive terminal 320 is merely connected to the first conductive contact 230 and the second internal conductive terminal 330 is merely connected to the second conductive contact 240. Therefore, the forgoing design can prevent the misconnection between the first internal conductive terminal 320 and the second internal conductive terminal 330 of the electrical connector 300 and the first conductive contact 230 and the second conductive contact 240 of the illuminating device 200.

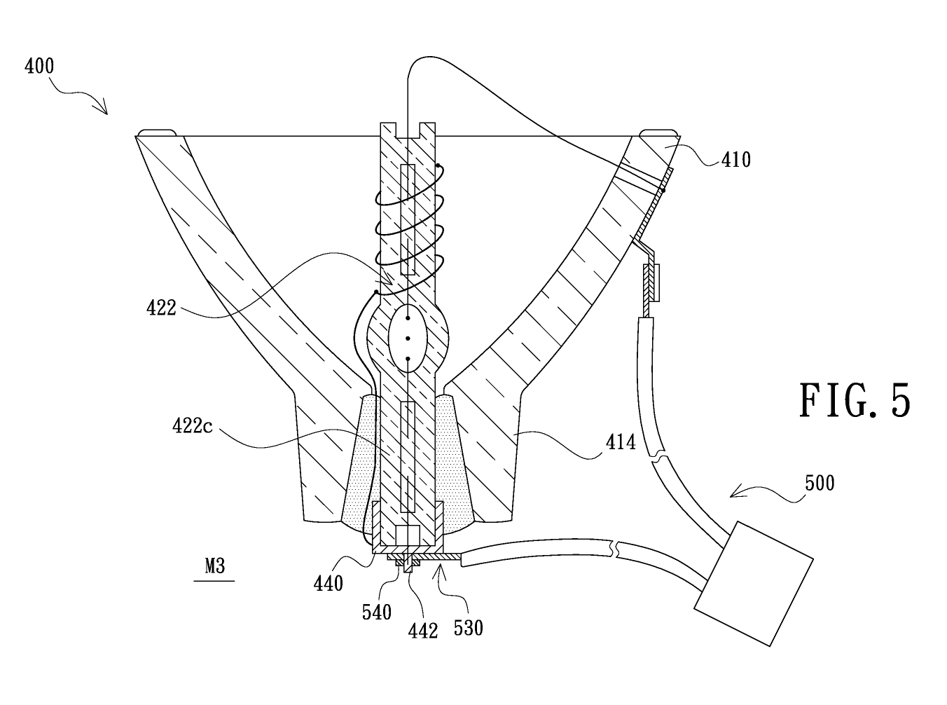

FIG. 5 is a schematic assembled view of an illuminating module according to another embodiment of the present invention. Referring to FIGS. 5 and 2, the difference between the illuminating module M3 of the present embodiment and the illuminating module M2 of the above embodiment is that the shape and disposition of the second conductive contact 440 of the illuminating device 400 of the illuminating module M3 of the present embodiment is different from those of the first conductive contact 240 of the above embodiment.

In the present embodiment, the second conductive contact 440 is disposed at the base portion 414 of the reflector 410 and the sealed portion 422c of the tube 422 is inserted into the second conductive contact 440. In addition, the column body 442 of the second conductive contact 440 is inserted into the second internal conductive terminal 530 of the electrical connector 500. The column body 442 of the second conductive contact 440 is, for example, a bolt. The second internal conductive terminal 530 is fixed to the second conductive contact 440 through the fixing member 540 such as a nut screwed to the column body 442.

According to the mentioned above, the illuminating module of the embodiment of the present invention has at least one of the following or other advantages. The connection manner between the first internal conductive terminal and the first conductive contact belongs to fool-proof connection and the connection manner between the second internal conductive terminal and the second conductive contact belongs to fool-proof connection. So, when the electrical connector is assembled to the illuminating device, the first internal conductive terminal is merely connected to the first conductive contact and the second internal conductive terminal is merely connected to the second conductive contact. Therefore, the design of the illuminating module of the present invention can prevent the misconnection between the first internal conductive terminal and the second internal conductive terminal of the electrical connector and the first conductive contact and the second conductive contact of the illuminating device.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An electrical connector applied to an illuminating device having a first conductive contact and a second conductive contact, comprising:
an external plug;
a first internal conductive terminal electrically connected to the external plug and suitable for being electrically connected to the first conductive contact; and
a second internal conductive terminal electrically connected to the external plug and suitable for being electrically connected to the second conductive contact, wherein the connection manner between the first internal conductive terminal and the first conductive contact and the connection manner between the second internal conductive terminal and the second conductive contact belong to fool-proof connection.

2. The electrical connector as claimed in claim 1, wherein the connection manner between the first internal conductive terminal and the first conductive contact is different from the connection manner between the second internal conductive terminal and the second conductive contact.

3. The electrical connector as claimed in claim 2, wherein the connection manner between the first internal conductive terminal and the first conductive contact is tight fit, the connection manner between the second internal conductive terminal and the second conductive contact is loose fit and the second internal conductive terminal is fixed to the second conductive contact through a fixing member.

4. The electrical connector as claimed in claim 3, wherein the first internal conductive terminal has a body and two bended portions, each of the bended portions is connected to the body and keeps a first distance from the body, the bended portions keep a second distance from each other and the first conductive contact is suitable for being inserted between each of the bended portions and the body so that the first conductive contact is sandwiched between each of the bended portions and the body.

5. The electrical connector as claimed in claim 3, wherein the second internal conductive terminal has a through hole into which the second conductive contact is suitable for being inserted and the fixing member is a nut which is screwed to the second conductive contact so that the second internal conductive terminal is fixed to the second conductive contact.

6. An illuminating module comprising:
an illuminating device having a first conductive contact and a second conductive contact; and
an electrical connector comprising:
an external plug;
a first internal conductive terminal electrically connecting the external plug and the first conductive contact; and
a second internal conductive terminal electrically connecting the external plug and the second conductive contact, wherein the connection manner between the first internal conductive terminal and the first conductive contact and the connection manner between the second internal conductive terminal and the second conductive contact belong to fool-proof connection.

7. The illuminating module as claimed in claim 6, wherein the connection manner between the first internal conductive terminal and the first conductive contact is different from the connection manner between the second internal conductive terminal and the second conductive contact.

8. The illuminating module as claimed in claim 7, wherein the connection manner between the first internal conductive terminal and the first conductive contact is tight fit, the connection manner between the second internal conductive terminal and the second conductive contact is loose fit and the second internal conductive terminal is fixed to the second conductive contact through a fixing member.

9. The illuminating module as claimed in claim 8, wherein the first internal conductive terminal has a body and two bended portions, each of the bended portions is connected to the body and keeps a first distance from the body, the bended portions keep a second distance from each other and the first conductive contact is inserted between each of the bended portions and the body so that the first conductive contact is sandwiched between each of the bended portions and the body.

10. The illuminating module as claimed in claim 8, wherein the second internal conductive terminal has a through hole into which the second conductive contact is inserted and the fixing member is a nut which is screwed to the second conductive contact so that the second internal conductive terminal is fixed to the second conductive contact.

11. The illuminating module as claimed in claim 6, wherein the illuminating device comprising:
a reflector having an opening and a base portion opposite to the opening, wherein the first conductive contact is disposed at the reflector and located outside the reflector and the second conductive contact is disposed at the reflector and at least partly located outside the reflector; and
a lamp fixed to the base portion and at least partly disposed in the reflector, wherein the lamp has a first electrode and a second electrode and the first electrode and the second electrode are electrically connected to the first conductive contact and the second conductive contact, respectively.
